(19) United States
(12) Patent Application Publication
(10) Pub. No.: US 2010/0053453 A1
(43) Pub. Date: Mar. 4, 2010

(54) DIGITAL MEDIA CONTROLLER

(75) Inventors: MING-FENG TSAI, Tu-Cheng (TW); CHIA-YU CHENG, Tu-Cheng (TW); XIAO-GUANG LI, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) Co., LTD., Shenzhen City (TW); HON HAI PRECISION INDUSTRY CO., LTD., Tu-Cheng (TW)

(21) Appl. No.: 12/500,577

(22) Filed: Jul. 9, 2009

(30) Foreign Application Priority Data
Sep. 3, 2008 (CN) 200810304358.8

(51) Int. Cl. H04N 5/268

(52) U.S. Cl. 348/705; 348/E05.057

(57) ABSTRACT

A digital media controller is provided. The digital media controller includes a video input interface configured for connecting to a host computer; a video output interface configured for connecting a display; a storage card interface configured for receiving a storage card which is used to store media files; a media processing unit configured for decoding the media files to video signals and audio signals; a switch unit connected between the video input interface and the video output interface, and the media processing unit, and controlled by the processor; the processor being configured to control the switch unit to connect a signal channel between the video input interface and the video output interface, and between the media processing unit and the video output interface according to a predetermined control rule.

### BACKGROUND

1. Technical Field

The disclosure relates to a digital media controller and a method of controlling the digital media controller.

2. General Background

Digital cameras, digital photo frames (DPF), personal digital assistants (PDA), and the like are widely used, and are convenient for users to enjoy digital media such as photos, videos, and so on. However, the size of the display of electronic devices is often very small and users cannot comfortably enjoy the media.

Generally, a method is used to directly connect the electronic device mentioned above to a computer system through a data cable such as a universal serial bus (USB) cable, thereby displaying the contents of the media files on the display of the computer system by accessing a storage card of the electronic device through the USB cable. Another method is to remove the storage card from the electronic device, and insert it into a storage card interface of the computer system, thereby the computer system directly accesses the media files stored in the storage card through the storage card interface, and displays the contents of the media files on the display of the computer system. However, when the methods mentioned above are adopted, the user must manually select which media files stored in the storage card to display, which is inconvenient because the user must browse through the media files in the electronic device to find what they want.

Therefore, it is necessary to provide a digital media controller and control method which can overcome the above-mentioned problem.

### BRIEF DESCRIPTION OF THE DRAWINGS

FIG. 1 is a schematic diagram showing a digital media controller connected to a host computer system in accordance with an exemplary embodiment.

FIG. 2 is a block diagram showing the internal configuration of the digital media controller of FIG. 1, in accordance with an exemplary embodiment.

FIG. 3A is a flowchart of displaying the video signals output by the host computer of FIG. 1, in accordance with an exemplary embodiment.

FIG. 3B is a flowchart of displaying the video signals output by the media processing unit of the digital media controller of FIG. 2 in accordance with an exemplary embodiment.

FIG. 4 is a flowchart of updating the media files in the storage card via the digital media controller of FIG. 2, in accordance with an exemplary embodiment.

### DETAILED DESCRIPTION

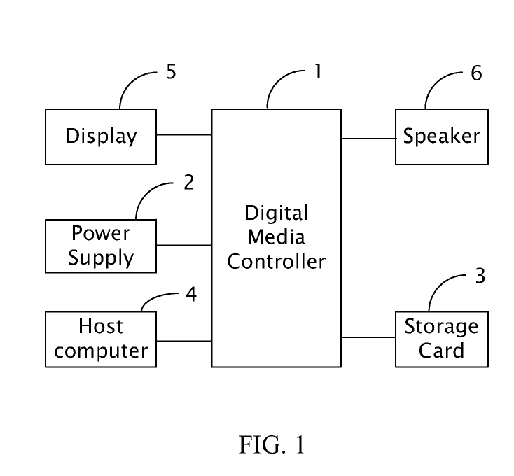

FIG. 1 is a schematic diagram showing a digital media controller connected with a host computer system in accordance with an exemplary embodiment of the disclosure. The digital media controller 1 is electrically connected to a power supply 2, a storage card 3, a host computer 4, a display 5, and at least one speaker 6. The host computer 4 and the display 5 form a computer system. The power supply 2 is configured for supplying power to the digital media controller 1, the host computer 4, and the display 5. The storage card 3 may be a plug and play (PnP) type storage card, which is configured for storing media files and control programs. The media files may be image files, video files, audio files, and the like. The digital media controller 1 is configured to control the display 5 to display video signals output by the host computer 4, or video signals of media files stored in the storage card 3.

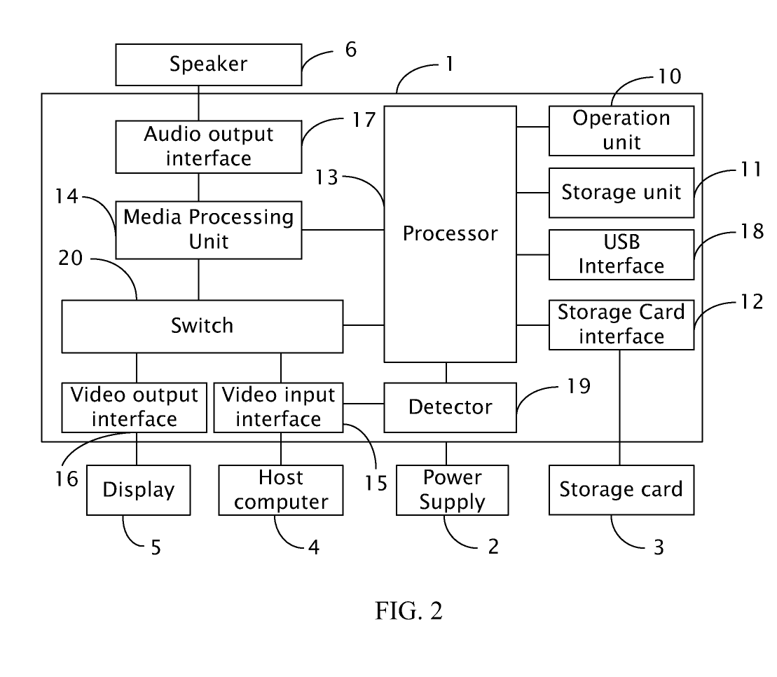

FIG. 2 is a block diagram showing the internal configuration of the digital media controller of FIG. 1. The digital media controller 1 includes an operation unit 10, a storage unit 11, a storage card interface 12, a processor 13, a media processing unit 14, a video input interface 15, a video output interface 16, an audio output interface 17, and a USB interface 18.

The operation unit 10 is configured for transmitting control commands to the processor 13 according to operations from users. The control commands are used to activate various functions, for example, selecting media files, playing media files, copying media files, and the like. The storage unit 11 is configured for storing a plurality of system programs of the digital media controller 1. The storage card interface 12 is configured to connect to the storage card 3. The processor 13 is configured for performing corresponding functions according to the control commands transmitted by the operation unit 10. The media processing unit 14 is configured for decoding the media files selected by the processor 13 to video signals and audio signals. The video input interface 15 is configured for receiving video signals output by the host computer 4. The video output interface 16 is configured for outputting video signals from the media processing unit 14 or from the video input interface 15 to the display 5. The audio output interface 17 is configured for outputting the audio signals to the at least one speaker 6. The USB interface 18 is configured for the digital media controller 1 to establish communication with the host computer 4 or other external electronic devices. In another embodiment, the at least one speaker 6 can be integrated into the digital media controller 1.

The digital media controller 1 further includes a detector 19 and a switch unit 20. The detector 19 is connected between the video input interface 15 and the processor 13, and used for detecting whether video signals are received from the host computer 4. The switch unit 20 is connected between the video input interface 15 and the video output interface 16, and the media processing unit 14, and further controlled by the processor 13, in the exemplary embodiment, to connect a first signal channel between the video input interface 15 and the video output interface 16, or a second signal channel between the multimedia processing unit 14 and the video output interface 16.

The processor 13 is configured to control the switch unit 20 to select a corresponding signal channel according to a predetermined control rule. The control rule may be displaying video signals output by the host computer 4 with higher priority, displaying comments of the media files of the storage card 3 with higher priority, last input and first output (LIFO) rule, or the like.

If the control rule is displaying video signals output by the host computer 4 with higher priority, the processor 13 controls the switch unit 20 to connect the first signal channel between the video input interface 15 and the video input interface 16. The first signal channel is connected without consideration of the absence or presence of the storage card 3 in the storage card interface 12. If the video signals output by the host computer 4 are not detected, the processor 13 is configured to control the switch unit 20 to connect the second signal channel between the media processing unit 14 and the video output interface 16 when the storage card 3 is inserted in the storage card interface 12. The processor 13 selects media files stored in the storage card 3 according to the commands input by the operation unit 10. The media processing unit 14 decodes the selected media files into video signals and audio signals. The video signals are transmitted to the display 5 to display through the switch unit 20 and the video output interface 16, the audio signals are transmitted to the speaker 6 via the audio output interface and the speaker 6 converts the audio signals to audible sound.

If the control rule is displaying comments of the media files of the storage card 3 with higher priority, the processor 13 controls the switch unit 20 to connect the second signal channel between the media processing unit 14 and the video output interface 16. The channel is connected without consideration of the presence or the absence of video signals from the video input interface 15 when the storage card 3 is inserted in the storage card interface 12. If the storage card 3 is not inserted in the storage card interface 12, the processor 13 controls the switch unit 20 to connect the first signal channel between the video input interface 15 and the video output interface 16 for when video signals from the host computer 4 are transmitted through the video input interface 15.

If the control rule is last input and first output (LIFO) rule, the processor 13 performs corresponding program as follows: if the video signals input by the host computer 4 are detected on the video input interface 15 when video signals from the storage card 3 are being displayed, the processor 13 controls the switch unit 20 to connect the first signal channel between the video input interface 15 and the video output interface 16. On the contrary, when the video signals output by the host computer 4 are being displayed, the processor 13 controls the switch unit 13 to connect the second signal channel between the media processing unit 14 and the video output interface 16 once the storage card 3 is detected in the storage card interface 12.

The processor 13 is also configured to update the files in the storage card 3 when new media files are detected in the host computer 4 and the digital media controller 1 is connected to the host computer via the USB interface 18. Firstly, the processor 13 determines whether the host computer 4 stores new media files by comparing the media files stored in the host computer 4 with the media files stored in the storage card. If there are media files found stored in the host computer 4 that are not stored in the storage card 3, the media files are considered new media files. Secondly, the processor 13 determines whether there is space available for storing the new media files in the storage card 3 and stores as many of the new media files in the storage card 3 according to the volume of the available space in the storage card 3.

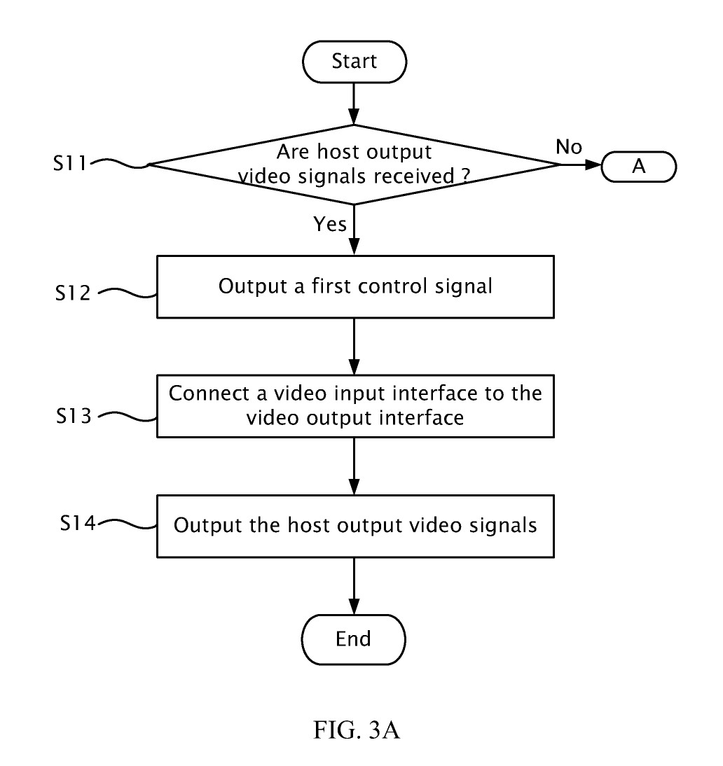

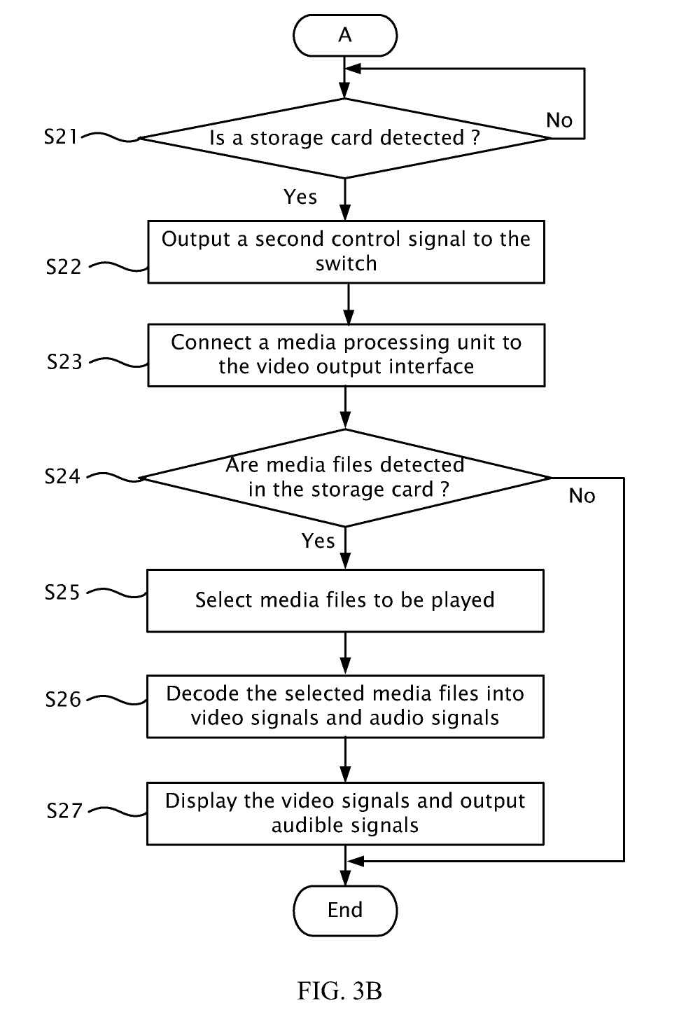

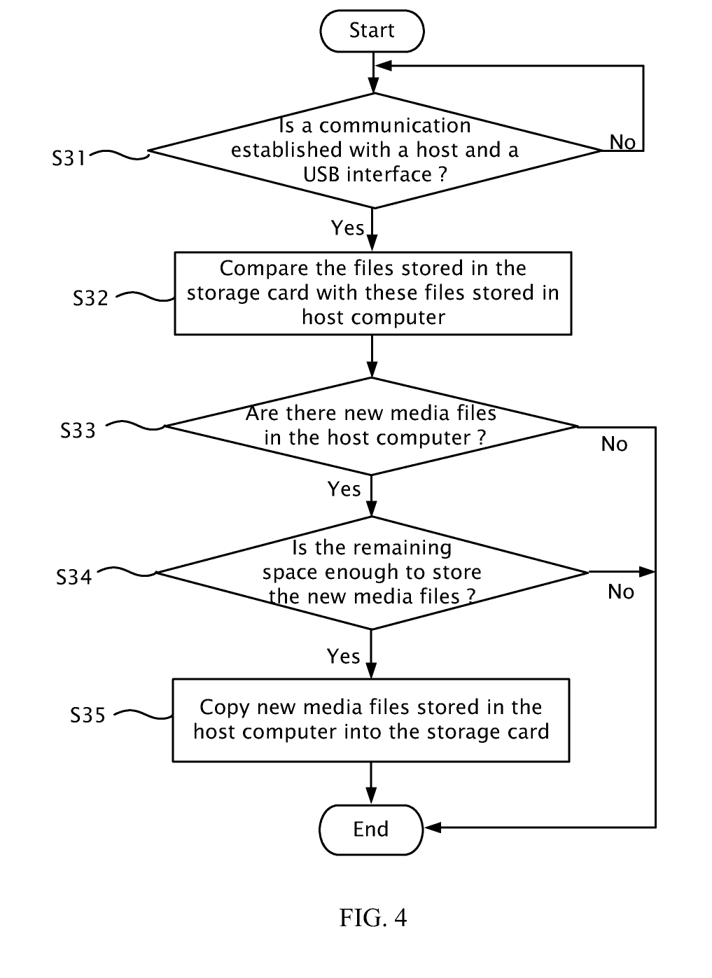

FIGS. 3A and 3B are flowcharts of displaying video signals output by the host computer 4 with higher priority. FIG. 3A is a flowchart of displaying the video signals output by the host computer 4 in accordance with an exemplary embodiment of the present disclosure. In step S11, the processor 13 determines whether a video signals output by the host computer 4 are received. If video signals output by the host computer 4 are not received, the procedure goes to FIG. 4 described below. If video signals output by the host computer 4 are received, the procedure goes to step S12. In step S12, the processor 13 outputs a first control signal. In step S13, the switch unit 20 connects the first signal channel from the video input interface 15 to the video output interface 16 according to the first control signal. In step S14, the display 5 displays the video files output by the host computer 4.

FIG. 3B is a flowchart of displaying the video signals output by the media processing unit 14 with higher priority. When video signals output by the host computer 4 are not detected in FIG. 3, the procedure goes to step S21 in FIG. 4. In step S21, the processor 13 determines whether the storage card 3 is presented in the storage card interface 12. If the storage card 3 is not presented in the storage card interface 12, the procedure goes back to step S11 in FIG. 3. If the storage card 3 is presented in the storage card interface 12, the procedure goes to step S22. In step S22, the processor 13 outputs a second control signal. In step 23, the switch unit 20 connects the second signal channel from media processing unit 14 to the video output interface 16 according to the second control signal. In step S24, the processor 13 determines whether there are media files stored in the storage card 3. If there are not media files stored in the storage card 3, the procedure ends. If there are media files stored in the storage card 3, the procedure goes to step S25. In step S25, the processor 13 selects media files from the storage card 3 under the control of the operation unit 10. In step S26, the media processing unit 14 decodes the media files selected by the processor 13 to video signals and audio signals. In step S27, the display 5 displays the video signals through the switch unit 20 and the video output interface 16, and the speaker 6 converts the audio signals to audible sound to users through the audio output interface 17.

FIG. 4 is a flowchart of updating the media files in the storage card 3 in accordance with an exemplary embodiment of the present disclosure. In step S31, the processor 13 determines a communication is established with the host computer 4 through a USB interface 18. In step S32, the processor 13 compares the media files stored in the storage card 3 with the media files stored in the host computer 4. In step S33, the processor 13 determines whether media files exist in the host computer 4 but not in the storage card 3, those media files exist in the host computer 4 but not in the storage card 3 are referred as new media files. If any new file is not detected in the host computer 4, the procedure ends. If any new media file is detected, the procedure goes to step S34, in which the processor 13 continue to determine whether the remaining space of the storage card 3 is able to store all or parts of the new media files. If the remaining space of the storage card 3 is unable to store a single new media file, the procedure ends. If the remaining space is enough to store all or parts of the media files, the procedure goes to step S35, in which the processor 13 copies all or parts of the media files stored in the host computer 4 to the storage card 3 depending on the remaining capacity of the storage card 3.

In another embodiment of the present disclosure, if the control rule is displaying video signals previously output by the host computer 4, the switch unit 20 has a normal status, which is used to connect the second signal channel between the video output interface 16 and the media processing unit 14. When the video signals output by the host computer 4 is detected, the processor 13 outputs a control signal to switch the switch unit 20 from the normal status to a controlled status. The controlled status is to connect the first signal channel between the video input interface 15 and the video output interface 16, in the controlled status, the display 5 displays the video signals output by the host computer 4.

FIGS. 3A and 3B are performed if the control rule is displaying comments of the media files of the storage card 3 with higher priority. In another alternative embodiment, the methods are similar to those recited in FIGS. 3A and 3B with other control rules.

Although the present disclosure has been specifically described on the basis of an exemplary embodiment thereof, the disclosure is not to be construed as being limited thereto. Various changes or modifications may be made to the embodiments without departing from the scope and spirit of the disclosure.

What is claimed is:

1. A digital media controller, comprising:
a video input interface configured for connecting to a host computer;
a video output interface configured for connecting a display;
a storage card interface configured for receiving a storage card which is used to store media files;
a media processing unit configured for decoding the media files to video signals and audio signals;
a switch unit connected between the video input interface and the video output interface, and the media processing unit, and controlled by the processor; the processor being configured to control the switch unit to connect a signal channel between the video input interface and the video output interface, and between the media processing unit and the video output interface according to a predetermined control rule,
wherein when the switch unit connects a signal channel between the video input interface and the video output interface, video signals from the host computer is displayed on the display, and when the switch unit connects a signal channel between the media processing unit and the video output interface, the video signals from the media processing unit is displayed on the display.

2. The digital media controller as claimed in claim 1, wherein the control rule is displaying video signals output by a host computer with higher priority, or displaying comments of media files of the storage card with higher priority, or last input and first output (LIFO) rule.

3. The digital media controller as claimed in claim 1, further comprising an operation unit configured for transmitting control commands according to operations from users.

4. The digital media controller as claimed in claim 1, wherein the processor is further configured to control the switch unit to connect the signal channel between the video input interface and the video output interface when video signals output by the host computer are detected, and connect the signal channel between the media processing unit and the video output interface when the video signals output by the host computer are not detected and the storage card is detected to present in the storage card interface.

5. The digital media controller as claimed in claim 1, wherein the switch unit has a normal status to connect the signal channel between the media processing unit and the video output interface and a controlled status to connect the signal channel between the video input interface and the video output interface.

6. The digital media controller as claimed in claim 1, wherein the processor is further configured to control the switch unit to connect the signal channel between the media processing unit and the video output interface when the storage card is detected to be present in the storage card interface, and connect the signal channel between the video input interface and the video output interface when the storage card is not detected to be present in the storage card interface and the video signals output by the host computer in the video input interface are detected.

7. The digital media controller as claimed in claim 1, wherein the processor is further configured to control the switch unit to connect the signal channel between the video output interface and the video input interface when the video signals output by the host computer are detected during the displaying of the video signals output by the media processing unit on the display.

8. The digital media controller as claimed in claim 1, wherein the processor is further configured to connect the signal channel between the media processing unit and the video output interface when the storage card is detected to be present in the storage card interface during the displaying of the video signals output by the media processing unit on the display.

9. The digital media controller as claimed in claim 1, further comprising an audio output interface, the audio output interface outputs the audio signals to a speaker.

10. The digital media controller as claimed in claim 1, further controller comprising a USB interface, wherein the processor is further configured to update media files from the host computer via the USB interface to the storage card.

11. The digital media controller as claimed in claim 10, wherein the processor is configured to update media files from the host computer via the USB interface to the storage card depending on the available capacity of the storage card.

12. The digital media controller as claimed in claim 10, wherein the processor is further configured to update media files from the host computer via the USB interface to the storage card, and to determine new media files which exist in the host computer but not exist in the storage card.

13. A method of controlling a digital media controller,
the digital media controller comprising a video input interface configured for connecting to a host computer;
a video output interface configured for connecting a display;
a storage card interface configured for receiving a storage card which is used to store media files;
a media processing unit configured for decoding the media files to video signals and audio signals;
a switch unit connected among the video input interface, the video output interface the media processing unit and controlled by the processor;
the method comprising:
controlling the switch unit to connect a signal channel between the video input interface and the video output interface, or between the media processing unit and the video output interface according to a predetermined control rule,
wherein when the switch unit connects the signal channel between the video input interface and the video output interface, the video signals from the host computer is displayed on the display, and when the switch unit connects the signal channel between the media processing unit and the video output interface, the video signals from the media processing unit is displayed on the display.

14. The method of controlling a digital media controller as claimed in claim 13, wherein the control rule is one of displaying video signals output by a host computer with higher priority, displaying comments of media files of the storage card with higher priority, or last input and first output.

15. The method of controlling a digital media controller as claimed in claim 13, further comprising:
controlling the switch unit to connect the signal channel between the video input interface and the video output interface when video signals output by the host computer are detected; and
connecting the signal channel between the media processing unit and the video output interface when the video signals output by the host computer are not detected and the storage card is detected to present in the storage card interface.

16. The method of controlling a digital media controller as claimed in claim 13, wherein the switch unit having a normal status to connect the signal channel between the media processing unit and the video output interface, and a controlled status to connect the signal channel between the video input interface and the video output interface.

17. The method of controlling a digital media controller as claimed in claim 13, further comprising:
controlling the switch unit to connect the signal channel between the media processing unit and the video output interface when the storage card is detected to present in the storage card interface, and
connecting the signal channel between the video input interface and the video output interface when the storage card is not detected present in the storage card interface and the video signals output by the host computer in the video input interface are detected.

18. The method of controlling a digital media controller as claimed in claim 13, further comprising:
controlling the switch unit to connect the signal channel between the video output interface and the video input interface when the video signals output by the host computer are detected during the displaying of the video signals output by the media processing unit on the display; and
connecting the signal channel between the media processing unit and the video output interface when the storage card is detected to present in the storage card interface during the displaying of the video signals output by the media processing unit on the display.
